(19) United States
(12) Patent Application Publication
(10) Pub. No.: US 2009/0282060 A1
(43) Pub. Date: Nov. 12, 2009

(54) REPRESENTING DIGITAL CONTENT METADATA

(75) Inventors: Igor Wilhelmus Franciscus Paulussen, Eindhoven (NL); Wilhelmus Henrica Gerarda Maria Van Den Boomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., EINDHOVEN (NL)

(21) Appl. No.: 12/305,205

(22) PCT Filed: Jun. 20, 2007
(86) PCT No.: PCT/IB07/52367

§ 371 Date: Dec. 17, 2008

(30) Foreign Application Priority Data
Jun. 23, 2006 (EP) 06115952.1

(51) Int. Cl. G06F 17/30

(52) U.S. Cl. 707/100; 707/200; 707/E17.005; 707/E17.01

(57) ABSTRACT

A method is presented for representing first metadata 260 according to a first standard, such as MPV, and associated with a digital content item 220 as second metadata 330 according to a second standard, such as UPnP CDS. The second metadata is associated with the same digital content item 450. The first metadata is part of an index file 200 capable of storing metadata 250, 260, 270, 280 for a plurality of digital content items 210, 220, 230, 240. The first metadata 260 is identifiable in the index file 200 through a content item identifier ID2. The method includes associating with the second metadata 220 an index file locator 331 representing a location in a storage where the index file 200 is stored; and the content item identifier ID2 in a field 332.

The invention relates to a method of representing first metadata according to a first standard and associated with a digital content item as second metadata according to a second standard and associated with a copy of the same digital content item.

The invention also relates to a system for performing the method.

The home environment is going through significant changes with respect to Audio, Video, Pictures (digital content) and their corresponding metadata. The PC and the CE worlds are integrating and form larger and larger home networks, shaping the Connected Home. Via these networks content and metadata from the PC, Digital Still Cameras, Camcorders, the Internet and television broadcast channels all becomes available in the living room. Two standards are important to offer the abovementioned functionality: UPnP for networking and MPV for metadata.

For operations in a networked system the Content Directory Service (CDS) within the Universal Plug and Play (UPnP) architecture is known. The current publicly available version of UPnP and CDS can be obtained from www.upnp.org. UPnP is a distributed, open networking architecture based on TCP/IP and Web technologies to enable seamless proximity networking in addition to control and data transfer among networked devices in the home, office, and public spaces. In addition to being an extension of the plug and play peripheral model, UPnP is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices. A device can leave a network smoothly and automatically without leaving any unwanted state behind. IP internetworking spans different physical media, enables multiple-vendor interoperation, and achieves synergy with the Internet and many home and office intranets. Via bridging, UPnP accommodates media running non-IP protocols.

Many devices within a UPnP compliant network, such as a UPnP home network, contain various types of content that other devices in the network would like to access (e.g. music, videos, still images, etc). As an example, a “Media Server” device might contain audio, video, and still-image library. In order for the user to enjoy this content, the user must be able to browse the items stored on the Media Server, select a specific one, and cause it to be “played” on an appropriate rendering device (e.g. an audio player for music items, a TV for video content, an Electronic Picture Frame for still-images, etc). It is desired that user can access the content without having to interact directly with the device containing the content. In order to enable this capability, the service device needs to provide a uniform mechanism for UI devices to browse the content on the server and to obtain detailed information about individual content items. To this end the UPnP architecture has defined the Content Directory Service (CDS). The Content Directory Service additionally provides a lookup/storage service that allows clients, e.g. user interface (UI) devices to locate (and possibly store) individual items (e.g. songs, movies, pictures, etc) that the (server) device is capable of providing. A further definition within the AV architecture is given for AV media servers in the document MediaServer:1 Device Template. The Media Server template defines a general-purpose device that can be used to instantiate any Consumer Electronic (CE) device that provides AV content (e.g. media) to other UPnP devices on the home network. It exposes its content via the Content Directory service. As such, the Media Server can handle any specific type of media, any data format, and transfer protocol. Example instances of a Media Server include traditional devices such as VCRs, CD Players, DVD Players, audio-tape players, still-image cameras, camcorders, radios, TV Tuners, and set-top boxes.

CDS is hierarchically organised in a manner similar to a computer file system. A so-called container (analogous to a folder or directory) can include a plurality of items (analogous to a file) and containers that are hierarchically one level lower. The item includes an item description with an identifier and optionally meta-data. The meta-data may include properties such as item name, artist, composer, date created, size, etc. The item may also include the actual content or include a locator, such as a URL, for locating the content. The CDS hierarchy is indicated by each container including a reference to its parent container (a bottom-up hierarchy: lower in the hierarchy points to higher in the hierarchy). A CDS server can easily build/verify the entire tree based on the individual items and their links.

The OSTA (Open Storage Technology Association) MPV (MusicPhotoVideo) standard is a standard for exchanging and playing collections of digital music, photos, and videos among consumer electronics devices and PCs on CDs, DVDs, memory cards, hard disks, home networks and across the internet. MPV is a series of XML-based specifications developed by the participating members of OSTA's MPV committee. MPV is comprised of a series of profiles and guidelines. The publicly available versions can be found at www.osta.org. The bases are the Core and Basic Profiles, which define all the assets and album or collection. On top of these, there are various types of profiles that address particular use cases, media types or product types. Finally, the Interoperability Specifications define strict or narrow uses of the profiles to ensure they can effectively be used in products with limited capabilities (limited processing power, memory, storage, etc.). MPV defines a playlist or the order of playback for a series of digital media (music, photo or video) files. A file is named an ‘asset’. A playlist file is an example of an MPV ‘manifest’. A manifest (e.g. playlist) is a form of an index file that includes location information (how to find the files/assets for rendering and/or manipulation) and all the metadata (subject, description, creator name, file format, etc.) associated with the digital media files/assets. The hierarchy in MPV is thus top-down. Products such as DVD players or wireless networked media adapters simply have to locate, load and parse the information in this single file to know everything about the content on a CD/DVD, memory card or remote home media server. MPV is a family of specifications or profiles each addressing either different media types or different product categories. MPV is XML based so it is easy to implement with “off-the-shelf” tools and extensible to future product categories and data types.

The Picture Archive and Sharing Standard (PASS) is a digital imaging industry initiative aimed at optimizing the digital imaging experience for consumers. In much the same way that today's consumer can get nearly any brand of film processed at any location, the PASS group wants to ensure that digital images can be retrieved from any digital device or storage medium. The images can be preserved and transitioned to future media technologies for decades through PASS unique migration features and support from key members of the photographic industry. PASS uses MPV as a common “table of contents” for the discs but extends it further to ensure compatibility. PASS extends MPV in various ways to speed and enhance searches and by defining which file formats must be supported to be PASS compliant.

When a user loads an album with assets complying the MPV on a media server (e.g. PC) with the intention to use it in the UPnP environment, typically a conversion of the MPV metadata to UPnP CDS metadata takes place in addition to copying the actual assets/files. Inherently, the metadata standardized by UPnP and standardized by MPV is not the same, and due to continuous new developments will probably never be fully the same. At this moment the standardized metadata in UPnP CDS Items is not so extensive as in MPV. For example, some digital cameras already support automatically/semi-automatically including GPS coordinates from where a photo is taken in the MPV metadata associated with the asset (photo). However, GPS coordinates is in UPnP not a standardized metadata field.

EP 1 475 702 describes a method for converting digital content metadata, as specified by TV-Anytime, into UPnP CDS metadata for use in the UPnP network. Metadata of TV-Anytime that can not be mapped onto standardized UPnP metadata fields is represented in a proprietary extension of UPnP CDS. Standard UPnP CDS devices can then not use the metadata in the extension, but extended devices may be able to use is. Each future discrepancy in metadata has to be remedied by a further proprietary extension.

It would be advantageous to provide a system and method of the kind set forth that is better capable of dealing with discrepancies in metadata between standards sets of metadata. It would also be desirable to be able to use information represented by original metadata items after the content has been moved/copied to another environment.

To better address this concern, in a first aspect of the invention a method of representing first metadata according to a first standard and associated with a digital content item as second metadata according to a second standard and associated with the same digital content item is presented, wherein the first metadata is part of an index file capable of storing metadata for a plurality of digital content items and wherein the first metadata is identifiable in the index file through a content item identifier, and wherein the method includes associating with the second metadata an index file locator representing a location in a storage where the index file is stored; and the content item identifier.

In this way, metadata items according to the first standard that can not be represented as metadata items according to the second standard (e.g. the second standard has not standardized such an item or the mapping is not one-to-one) can be located in the environment according to the second standard and as such be used. The second metadata may be associated with the actual same content item or a copy of that content item.

In an embodiment, the first standard is in conformance with the MusicPhotoVideo (MPV) standard; the digital content item being an MPV asset; the index file being an MPV manifest.

In an embodiment, the second standard is in conformance with the Content Directory Service (CDS) of the Universal Plug and Play (UPnP) standard.

In an embodiment, the method includes inserting the index file locator and the content item identifier into respective fields of the second metadata. In this way the association is maintained in a simple form. It may, for example, by achieved by using two proprietary fields according to the second standard. Alternative techniques for maintaining the association may also be used, such as using a separate linking file that links the second metadata to the index file locator and the content item identifier.

According to an aspect of the invention, the method includes monitoring a change in the index file locator and/or content item identifier and, in response to detecting a change, updating the association of the second metadata with the index file locator and/or content item identifier to reflect the change. In this way, the established association can be maintained. The monitoring may includes aspects such as renaming or moving the index file and/or content item.

In an embodiment, the method includes copying or moving the digital content item from a first environment wherein digital content items are described according to the first standard into a second environment wherein digital content items are described according to the second standard and associating the second metadata with the copied/moved digital content item.

According to an aspect of the invention, the method includes, as part of the copying/moving, selecting predetermined first metadata items which have corresponding items in the second metadata and mapping the selected first metadata items to the corresponding second metadata items, hereinafter referred to as mapped items. So, items that can be mapped are mapped, for fast and simple access in the new environment, and items that can not be easily mapped can be assessed through the established association.

In an embodiment, the method includes compiling an extended metadata item set for content management or use by a user interface device by including in the set the mapped items and additional items of the first metadata that have not been mapped and are located through the second metadata. This speeds up access to the entire set of metadata items.

According to an aspect of the invention, the method includes

copying or moving the digital content item from the second environment into a third environment wherein digital content items are described according to the first standard;

using the second metadata to locate the first metadata;

representing metadata of the digital content item in the third environment as third metadata in dependence on the first metadata.

In this way metadata items that have not/could not be mapped into the second environment can still be recovered from the original metadata items and be represented at the new location. For example, digital photos (first environment in the camera, e.g. MPV compliant) may be copied onto a PC (second environment, e.g. UPnP CDS compliant). At a later stage, part/all of the copied content is later copied to a further storage medium (e.g. USB key, portable storage device, such as multimedia player like an iPOD, or optical storage, such as DVD) for further rendering and/or manipulation. If the third environment complies with the first standard (e.g. MPV), now all original metadata items can still be retrieved from the second environment. The copying operation may be an archiving operation.

In an embodiment, the method includes mapping the mapped items of the second metadata to corresponding items in the third metadata. For the mapped items, the information form the second environment is used. This information may have been updated by the user compared to the original metadata. By keeping the possibly updated items instead of the possibly outdated original items, the metadata is kept up-to-date.

These and other aspects of the invention are apparent from and will be elucidated with reference to the embodiments described hereinafter.

In the drawings:

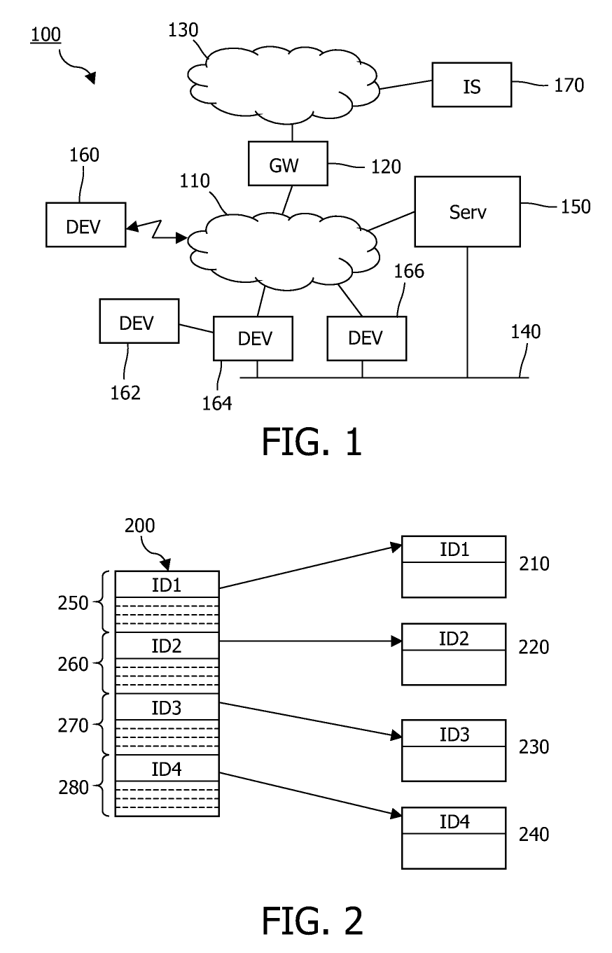

FIG. 1 shows a block diagram of an exemplary system in which the invention may be used;

FIG. 2 shows a structure for representing metadata according to a first standard, such as MPV;

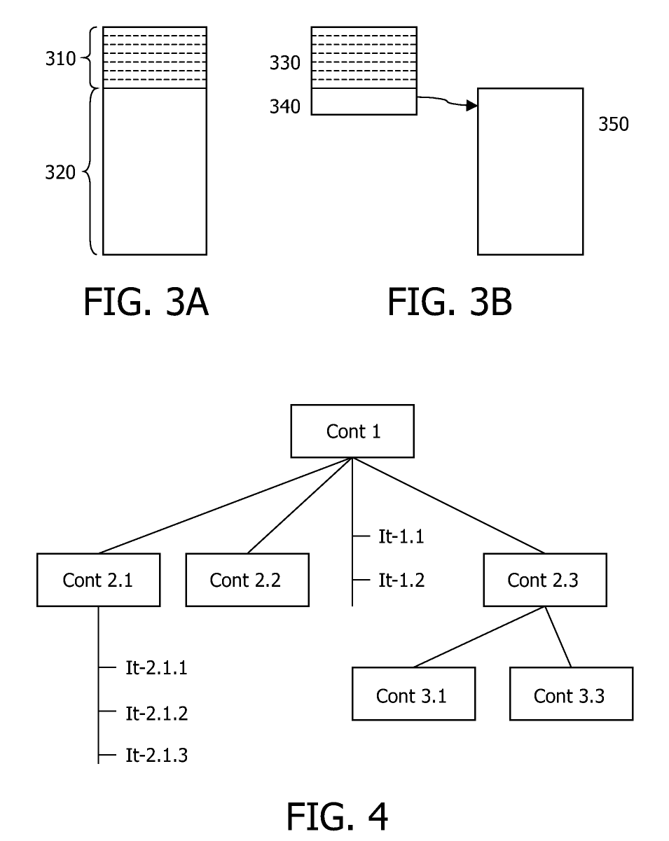

FIG. 3 shows a structure for representing metadata according to a second standard, such as UPnP CDS;

FIG. 4 shows a hierarchical container structure according to the second standard;

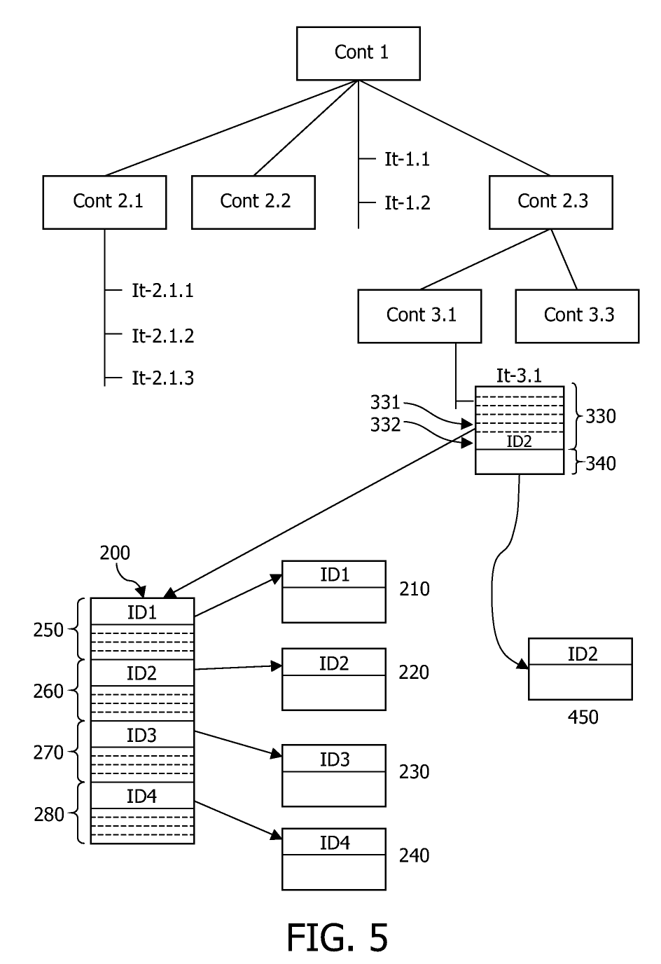

FIG. 5 illustrates representing metadata according to the first standard in the structure according to the second standard; and

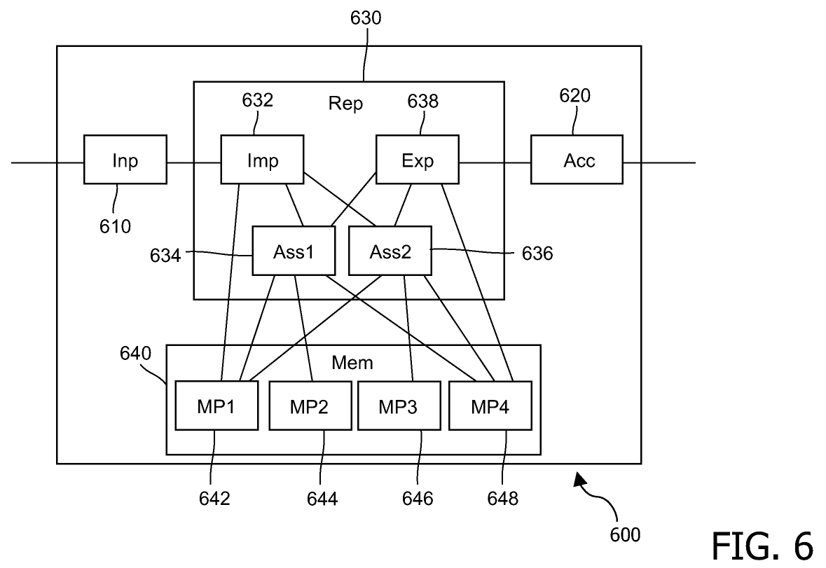

FIG. 6 shows an exemplary device implementing the method.

FIG. 1 shows a block diagram of an exemplary system 100 in which the invention may be used. The system couples metadata for the same digital content from two distinct environments. The digital content may take any multimedia form, such as audio, video, still images, etc. and in any format. In the first environment, the digital content is associated with first metadata according to conventions in the first environment. In an embodiment, the first environment is compliant with MPV. Other environments may also be used that meet the requirements as will be discussed in more detail with respect to FIG. 2 below. In the second environment, the same digital content (typically in the form of a copy of the original content) is associated with second metadata according to conventions in the second environment. In an embodiment, the second environment is compliant with UPnP CDS. Other environments may also be used that meet the requirements as will be discussed in more detail with respect to FIG. 3 below. Each of the environment includes a device. In principle, both environments may be executed in a single device, but in most practical situations each environment includes at least one own device with one or more device being able to participate in both environments and as such able to link both environments as described in the invention. For ease of discussion, in the remainder MPV will be used to represent the first environment and UPnP CDS to represent the second environment.

The exemplary system may include a network, such as a home network. In the figure a hierarchy of networks is shown. In this example, the main network 110 is a home network that may be based on the UPnP architecture. The description will focus on a UPnP network but it will be appreciated that the same concept can also be applied to non-UPnP system with a network and a CDS-like management of content in the system. UPnP is based on IP technology and supports many network media and higher level protocols. The media of the home network may be wired, e.g. from the Ethernet family of media, or wireless, such as based on IEEE 802.11 family of media. The system may, but need not, have links to an external network 130, such as the open Internet, for example through a gateway/router 120 coupled to the home network 110. The external network may also include devices, such as device 170 that may be an Internet server. The external network 130 could thus include or provide access to an MPV and/or UPnP device. A third network 140 may exist for the transfer of, in particular, streaming multimedia data, e.g. streaming AV data, in parallel to the home network 110. The third network may specially suited for isochronous transfer of digital content, for example using IEEE 1394, DVI, or HDMI. Portable devices, such as digital cameras, video cameras, PDAs, smartphones, etc. may also be connectable to the home network. Shown is a portable device 160 that is directly connected to the home network 110, for example though a bridge/router. A portable device may also be connected to a device that in turn is connected to the home network. For example, device 162 is connected to device 164 that is connected to the home network. For a link to a portable device any suitable wired or wireless technology may be used, for example using the USB protocol, IEEE 802.11, Bluetooth, or IEEE 1394.

In the description, a major role is given to the second environment (e.g. UPnP CDS) that may include a server device 150. The server device, such as a multimedia server may include a content directory service (hereinafter “CDS”), as will be describe in more detail later on. In principle, more devices may include a CDS. For simplicity only one device with a CDS is shown. The other devices, such as device 160, 162, 164, 166 are able to communicate with each other and/or with the server 150.

In the remainder, an exemplary scenario will be described wherein device 160 represents an MPV source device, such as a digital camera. The MPV content (or part of it) of this device will be copied or moved to the UPnP CDS server 150. At a later stage, all or part of this content will be moved or copied (e.g. archived) to an MPV device, represented by device 162.

Any of the devices may be implemented using conventional hardware and software. For example, the server 150 may be implemented on a personal computer platform, if so desired, with reliable background storage, such as a hard disk, a RAID system or rewritable DVD, for storing the CDS. The server 150 may also be implemented on a Consumer Electronics (CE) device, such as a receiver (e.g. set top box, multimedia server) with integrated hard disk. Rendering devices may be used, such as a TV, audio amplifier, etc. Source devices may be used, which may be any conventional CE source, but may also be a digital camera. User interface (UI) devices may be used, which may also be conventional CE devices, such as TVs, but may also be hand-held devices such as PDAs, or advanced programmable remote controls, etc. Each of the devices in the system includes the necessary hardware and/or software for communicating with at least one of the other devices through a suitable network connection.

FIG. 2 shows more details of the first environment. In this example, four digital content items 210, 220, 230 and 240 are shown, e.g. digital photos, or MP3 songs, etc. Each content item is associated with a respective content item identifier (ID). Shown are the respective identifiers ID1, ID2, ID3, and ID4. The identifier may take any suitable form, such as a file name, but may also be more powerful, such as a URL, URI, or URN. In the first environment, the content item itself may include metadata, as for example is the case for MP3. Irrespective of that metadata, in the first environment an index file 200 is used that includes metadata for content items covered by the index file. The part of the metadata in the index file that corresponds to a specific content item is identifiable in the index file through the content item identifier associated with of the content item. In the example of FIG. 2, the index file covers the four content items 210 to 240 and includes for each a respective portion of metadata 250 to 280, each identified by the respective content identifier. The content identifier may, for example, immediately precede the involved portion of metadata and thus identify the portion. Other forms of identifying the portion may also be used. For example, a mapping table may be used that maps each of the content identifiers to a respective pointer that points to the involved portion of metadata. As described above, in an embodiment the first environment is MPV compliant. MPV uses XML compliant descriptions. An example, of an MPV XML manifest with album ALB01 and assets ID01 (a still picture) and ID02 (a audio track) is:

```
<?xml version=“1.0” encoding=“UTF-8”?>
<file:Manifest
  xmlns:file=“http://ns.osta.org/manifest/1.0/”
  xmlns:mpv=“http://ns.osta.org/mpv/1.0/”
  xmlns:mpvp=“http://ns.osta.org/mpv/presentation/1.0/”
  xmlns:mpvm=“http://ns.osta.org/mpv/music/1.0/”
  xmlns:dc=“http://purl.org/dc/elements/1.1/”
  xmlns:dcterms=“http://purl.org/dc/terms/”
  xmlns:nmf=“http://ns.osta.org/nmf/1.0/”
  <nmf:Metadata>
  <ManifestProperties xmlns=“http://ns.osta.org/manifest/1.0/”>
    <ProfileBag>
    <Profile>http://ns.osta.org/mpv/basic/1.0/</Profile>
    <Profile>http://ns.osta.org/mpv/presentation/1.0/</Profile>
    <Profile>http://ns.osta.org/mpv/music/1.0/</Profile>
    </ProfileBag>
  </ManifestProperties>
  </nmf:Metadata>
  <mpvp:Album mpv:id=“ALB01”>
  <nmf:Metadata>
    <dc:Properties>
    <dc:Title>Hawaii</dc:Title>
    <dc:Creator>Philips Research</dc:Creator>
    <dc:Description>Holiday to Hawaii, 2005</dc:Description>
  </dc:Properties>
  <dcterms:Properties>
    <dcterms:Created>2005-03-03T12:05:00Z</dcterms:Created>
  </dcterms:Properties>
  </nmf:Metadata>
  <mpvp:Background>
  </mpvp:Background>
  <mpvp:Foreground>
  <mpv:StillRef mpv:idRef=“ID01”/>
  <mpv:AudioRef mpv:idRef=“ID02” />
  </mpvp:Foreground>
</mpvp:Album>
<mpv:AssetList>
  <mpv:Still mpv:id=“ID01”>
  <nmf:Metadata>
    <dc:Properties>
    <dc:Title>Holiday in Hawaii</dc:Title>
    <dc:Creator>Philips Research</dc:Creator>
    <dc:Description>2005: Hawaii Holiday</dc:Description>
    </dc:Properties>
    <dcterms:Properties>
    <dcterms:Created>2005-02-03T15:07:00Z</dcterms:Created>
    </dcterms:Properties>
  </nmf:Metadata>
  <mpv:LastURL>Hawaii/Hawaii.jpg</mpv:LastURL>
  </mpv:Still>
  <mpv:Audio mpv:id=“ID02”>
  <nmf:Metadata>
    <dc:Properties>
    <dc:Title>Stir It Up</dc:Title>
    </dc:Properties>
    <mpvm:MusicProperties>
      <mpvm:PrincipalArtist>Bob Marley And The
      Wailers</mpvm:PrincipalArtist>
      <mpvm:AlbumTitle>One Love, The Best Of</mpvm:AlbumTitle>
      <mpvm:Recorded>2001</mpvm:Recorded>
      <mpvm:Genre>Alternative</mpvm:Genre>
      <mpvm:TrackNumber>1</mpvm:TrackNumber>
      <mpvm:PlayingTime>3:41</mpvm:PlayingTime>
      <mpvm:EncodedBitrate>192 kbps / 44.1 kHz /
      Stereo</mpvm:EncodedBitrate>
    </mpvm:MusicProperties>
    </nmf:Metadata>
    <mpv:LastURL>Hawaii/StirItUp.mp3</mpv:LastURL>
  </mpv:Audio>
  </mpv:AssetList>
</file:Manifest>
```

For asset ID01, the index file includes metadata, such as title, creator, and a description. For asset ID02, the index file includes metadata, such as principal artist, album title, when recorded, genre, track number, etc.

FIG. 3 shows more details of the second environment. Each content item (object) includes an item description. The description may include several fields, like an identifier, such as a name. In particular, the item description includes metadata describing the content. For example, for an audio title such metadata may include the name of a singer/artist, composer and producer, and recording data, such as a recording company, studio, etc. In addition to the content description, the item also includes actual content, such as an MP3 file or a JPEG file. This is shown in FIG. 3A where the item includes a content description 310 and actual content 320. FIG. 3B shows an alternative arrangement wherein, instead of containing the actual content, the item may in fact include a content locator 340, such as a URL, that enables locating the actual content 350. In principle, the content description may also refer to some of the fields to another location, e.g. a server on the Internet. Part 330 represents the same content description as 310 in FIG. 3A. As described above, in an embodiment the second environment is UPnP CDS compliant.

FIG. 4 shows for the UPnP CDS embodiment more details on the role of a server, also referred as media server. The server includes the Content Directory Service (CDS). The content is created or captured in a subsystem that may be located in another device. For example, a movie may be received by a tuner or supplied on disk into a DVD player. A photo may be supplied by a digital camera or scanned through a scanner. The actual content may be stored in the CDS, but may also be stored somewhere else, e.g. in a content storage database. The Content Directory Service, CDS, provides a set of actions that allow a device (Control Point in UPnP terminology) in the home network to enumerate the content that the Server can provide to the home network. For example, a device can obtain detailed information about each Content Item that the Server can provide. This information (i.e. meta-data) includes properties such as its name, artist, date created, size, etc. The Content Directory Service includes a hierarchical structure of containers. Such container can be seen as equivalent to folders/directories in a file system. In principle a container may also be physically represented as a directory. It may also be represented differently, e.g. the entire CDS may be one file with an internal structure that makes identification of and access to containers/items possible. FIG. 4 shows an example of a hierarchical structure with six containers Cont 1, Cont 2.1, Cont 2.2, Cont 2.3, Cont 3.1 and Cont 3.3. The exemplary CDS at that moment contains three hierarchical layers, layer 1 with Cont 1, layer 2 with Cont 2.1, Cont 2.2, and Cont 2.3, layer 3 with Cont 3.1 and Cont 3.3. The top container (Cont 1) is also referred to as root. Preferably, each container can also include items, in particular but not limited to AV content, such as an audio title, movie, photographs, etc. The system can also work if, for example, only the lowest layer of containers can include items. In the example of FIG. 4, Cont 1 includes two items It-1.1 and It-1.2; and container Cont 2.1 includes three items It-2.1.1, It-2.1.2, and It-2.1.3. In principle, the CDS is dynamic, in the sense that a user can determine the containers in the CDS and the hierarchy among the containers.

According to an aspect of the invention, metadata from the first environment (hereinafter also referred to as first metadata) and complying with the first standard is represented and associated with a digital content item as second metadata. The second metadata complies with a distinct, second standard. The second metadata is associated with the same content item as the first metadata is. This covers both the situation wherein the first and second metadata are associated with a same, single copy of the content items as well as the situation wherein the first and second metadata are associated with respective copies of the content item. Representing the first metadata in the second metadata is done by associating with the second metadata an index file locator representing a location in a storage where the index file used in the first environment is stored; and the content item identifier used in the first environment for identifying which part of the metadata in the index file corresponds to the content item involved. FIG. 5 shows an embodiment of how this can be done in the context of MPV and UPnP CDS.

FIG. 5 takes as a starting point the CDS environment represented in FIG. 4. It is now assumed that the content item from the first environment identified by ID2 in FIG. 2 is incorporated into the CDS. In this example, a new item 3.1 is created in container 3.1 in the CDS for this new content item. In this example, the new item 3.1 takes the structure of FIG. 3B, but equally well structure 3A may be used. Where the same numerals are used, they refer to the same/similar items as before. Item 3.1 includes an item description 330 with its own metadata. It also includes a content locator 340, such as a URL, that enables locating the actual content 450. In this case, the actual content 350 is a copy of the content item 220. If content item 220 is accessible from the second environment (e.g. both environments are on a same PC), item 350 may actually be the same as item 220, in which case the content locator 340 can simply point to item 220. Two new fields are created in the description part 330 of item 3.1. The first new field 331 enables locating the index file 200 in its storage. In this example, field 331 includes a pointer, such as a URL. The second field enables locating the involved part of the metadata stored in the index file 200. This may be done by storing in the second new field 332 the content item identifier ID2 that makes the first metadata in part 260 identifiable in the index file 200.

It will be appreciated that in this embodiment, the index file locator and the content item identifier are inserted into respective fields 331 and 332 of the second metadata 330. Other alternative means of associating the first metadata in part 260 and the second metadata 330 may also be used. For example a separate mapping table may be used that maps the item identifier ‘3.1’ to the index file locator and the content item identifier.

In an embodiment, at least some of the relations that have been established above are monitored and for as far as possible maintained. To this end, a change in the index file locator and/or content item identifier is monitored. This may be done by extending the file system on top of which the CDS is built or though plug-ins into the CDS. In response to detecting a change, the association of the second metadata 330 with the index file locator and/or content item identifier are updated to reflect the change. For example, if ID2 is renamed in the first environment this will result in a change in the name in the index file 200 and the content item 260. This same change needs to be made to field 332. If the index file is moved in storage, the pointer in field 331 needs to be updated.

In an embodiment, the digital content item 220 is copied or moved from a first environment into the second environment. As part of the copying/moving operations, the associations are established as described above enabling to locate the original metadata. It will be appreciated that some of the original metadata 260 can be fully reflected in the standardized metadata part 330 in the second environment. For example, typically for an audio item both metadata standards will support metadata such as song title, artist, and composer. To that end, predetermined first metadata items are selected which have corresponding items in the second metadata. Those predetermined items are then mapped to the corresponding second metadata items, hereinafter referred to as mapped items. This mapping itself can be fully predetermined specifying for the different content types for each mappable field of the first metadata standard to which field of the second metadata standard it should be mapped.

In an aspect according to the invention, an application program that requires access to the metadata of a content item in the second environment (e.g. UPnP CDS) can use the standard fields in part 330 to obtain most of the metadata. If the program also desires access to some metadata fields not supported by this standard, it can follow the link in fields 331 and 332 to locate the part 260. To interpret these additional fields it will require knowledge of the first standard, e.g. MPV, as well. To speed up presenting the entire set of metadata available for a content item, according to an aspect of the invention, an extended metadata item set is compiled for content management or use by a user interface device. The extended set includes the metadata items that have already been mapped into part 330 and the additional items in part 260 of the first metadata that have not been mapped and are locatable through the second metadata fields 331 and 332.

At a certain moment a user may want to copy or move one or more digital content items out of the second environment into a third environment that is compliant with the same standard as the first environment. For example, digital photos may have been moved from an MPV environment in the camera into a UPnP CDS environment on a PC and are now moved to a removable storage medium, such as a DVD or flash memory, with an MPV environment for archiving or rendering on another device. According to an aspect of the invention in such a situation, the second metadata (in particular fields 331 and 332 of FIG. 5) are used to locate the first metadata part 260. Metadata in the third environment is then created depending on the first metadata 260. In an embodiment, simply the metadata part 260 is copied. In another embodiment, the third metadata also depends on the second metadata 330. In particular, the items of the first metadata 260 that had been mapped onto corresponding fields in second metadata 330 are now mapped from the fields in 330 to corresponding items in the third metadata. In this way any changes/updates that may have occurred in the second metadata 330 are now maintained.

FIG. 6 shows a block diagram of an exemplary device 600 capable of performing the metadata representation according to the invention. The device 600 has input means 610 for retrieving information from the first environment, e.g. form an MPV environment. This includes being able to locate the index file (i.e. determine a locator for it) and to locate the relevant metadata part in this index file. A simply way of achieving this is establishing a form of communication with the first embodiment, for example by inserting a storage with the first memory into the device 600, where device 600 is equipped with a suitable slot for receiving the storage, or by communication to a device with the first environment through a network like USB, Bluetooth or WiFi. Device 600 further includes means 620 for accessing the second environment, e.g. for the CDS environment this may include creating/modifying items and/or containers in CDS. Device 600 further includes means 630 for representing the first metadata according to a first standard and associated with a digital content item as second metadata according to a second standard and associated with a copy of the same digital content item by associating with the second metadata an index file locator representing a location in a storage where the index file is stored and the content item identifier, as described in detail above. Device 600 may be implemented on a PC using suitable hardware (e.g. for importing and exporting digital content and metadata) and software for causing a processor to perform the representation and optional mappings. As such, block 630 may be executed on a processor. In an embodiment, block 630 may be subdivided into sub-blocks, such as:

block 632 for importing the information retrieved from the first environment through the input means 610,

block 634 for associating with the second metadata an index file locator representing a location in a storage where the index file is stored,

block 636 for associating with the second metadata the content item identifier, block 638 for exporting the new associations to the second environment through means 620.

In further embodiment, block 630 may include sub-blocks (not shown in FIG. 6):

for inserting the index file locator and the content item identifier into respective fields of the second metadata,

for monitoring a change in the index file locator and/or content item identifier and, in response to detecting a change, updating the association of the second metadata with the index file locator and/or content item identifier to reflect the change,

for copying or moving the digital content item from a first environment wherein digital content items are described according to the first standard into a second environment wherein digital content items are described according to the second standard and associating the second metadata with the copied/moved digital content item,

for, as part of the copying/moving, selecting predetermined first metadata items which have corresponding items in the second metadata and mapping the selected first metadata items to the corresponding second metadata items, hereinafter referred to as mapped items,

for compiling an extended metadata item set for content management or use by a user interface device by including in the set the mapped items and additional items of the first metadata that have not been mapped and are located through the second metadata,

for copying or moving the digital content item from the second environment into a third environment wherein digital content items are described according to the first standard; and a sub-block for using the second metadata to locate the first metadata; and a sub-block for representing metadata of the digital content item in the third environment as third metadata in dependence on the first metadata; and

for mapping the mapped items of the second metadata to corresponding items in the third metadata.

All of such sub-blocks may be implemented as separate hardware block or software function and/or software modules and/or software objects. A skilled person may also choose another suitable arrangement for performing the functionality described above. Device 600 may include a memory or storage 640 for storing the data relevant for performing the representation. The memory 640 may be arranged in separate parts. For example, the memory/storage 640 may include:

a memory part 642 may be used for storing the index file or data from the index file imported by sub-block 632,

a memory part 644 for storing the association created by sub-block 634,

a memory part 646 for storing the association created by sub-block 636,

a memory part 648 for storing the data to be exported by sub-block 638,

For example, sub-block 632 may store the retrieved information inn block 642 and additionally or alternatively supply it directly to block 634. Sub-block 634 may use this information, perform its described task and store the outcome and/or intermediate result in memory part 644. Sub-block 634 may also store the outcome directly in memory part 648 for exporting it or supply it directly to block 638 for exporting. A same way of working as described for sub-block 634 may also be performed for sub-block 636. Sub-block 638 may export the information accumulated in memory part 648 and/or directly obtained form sub-blocks 634 and 636. A skilled person will be able to define other memory/storage arrangements as well.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of representing first metadata (260) according to a first standard and associated with a digital content item (220) as second metadata (330) according to a second standard and associated with the same digital content item (450), where the first metadata is part of an index file (200) capable of storing metadata (250, 260, 270, 280) for a plurality of digital content items (210, 220, 230, 240) and where the first metadata (260) is identifiable in the index file (200) through a content item identifier (ID2); the method including associating with the second metadata (220):
an index file locator (331) representing a location in a storage where the index file is stored; and
the content item identifier (332, ID2).

2. A method as claimed in claim 1, including inserting the index file locator and the content item identifier into respective fields of the second metadata.

3. A method as claimed in claim 1, including monitoring a change in the index file locator and/or content item identifier and, in response to detecting a change, updating the association of the second metadata with the index file locator and/or content item identifier to reflect the change.

4. A method as claimed in claim 1, including copying or moving the digital content item from a first environment wherein digital content items are described according to the first standard into a second environment wherein digital content items are described according to the second standard and associating the second metadata with the copied/moved digital content item.

5. A method as claimed in claim 4, including as part of the copying/moving, selecting predetermined first metadata items which have corresponding items in the second metadata and mapping the selected first metadata items to the corresponding second metadata items, hereinafter referred to as mapped items.

6. A method as claimed in claim 4, including compiling an extended metadata item set for content management or use by a user interface device by including in the set:
the mapped items and
additional items of the first metadata that have not been mapped and are located through the second metadata.

7. A method as claimed in claim 4, including:
copying or moving the digital content item from the second environment into a third environment wherein digital content items are described according to the first standard; using the second metadata to locate the first metadata;
representing metadata of the digital content item in the third environment as third metadata in dependence on the first metadata.

8. A method as claimed in claim 6, including mapping the mapped items of the second metadata to corresponding items in the third metadata.

9. A method as claimed in claim 1, wherein the first standard is in conformance with the MusicPhotoVideo (MPV) standard; the digital content item being an MPV asset; the index file being an MPV manifest.

10. A method as claimed in claim 1, wherein the second standard is in conformance with the Content Directory Service (CDS) of the Universal Plug and Play (UPnP) standard.

11. A computer program product for causing a processor to perform the method of claim 1.

12. A system for representing first metadata according to a first standard and associated with a digital content item as second metadata according to a second standard and associated with a copy of the same digital content item, where the first metadata is part of an index file capable of storing metadata for a plurality of digital content items and where the first metadata is identifiable in the index file through a content item identifier; the system including means for associating with the second metadata:
an index file locator representing a location in a storage where the index file is stored; and
the content item identifier.
